(19) United States
(12) Patent Application Publication
(10) Pub. No.: US 2024/0430614 A1
(43) Pub. Date: Dec. 26, 2024

(54) ELECTRONIC INSTRUMENT AND ELECTRONIC KEYBOARD INSTRUMENT

(71) Applicant: CASIO COMPUTER CO., LTD., Tokyo (JP)

(72) Inventors: Hiroki AKAI, Tokyo (JP); So SATO, Tokyo (JP)

(21) Appl. No.: 18/742,647

(22) Filed: Jun. 13, 2024

(30) Foreign Application Priority Data
Jun. 26, 2023 (JP) 2023-103889

(51) Int. Cl. H04R 1/34; G10H 1/34; H04R 1/02; H04R 1/26

(52) U.S. Cl. CPC H04R 1/345; G10H 1/344; H04R 1/023; H04R 1/26; G10H 2220/221

(57) ABSTRACT

An electronic instrument includes a casing, a controller aligned in a left-right direction and extending in a front-back direction of the casing, a sound emitting unit within the casing, and a perforated unit having a wall along the left-right direction, a first sloping hole sloping from an inside towards an outside of the casing at an acute angle to the front-back direction in the wall, and a second sloping hole sloping from the inside towards the outside of the casing at a larger acute angle with respect to the front-back direction than the acute angle at which the first sloping hole slopes, and the perforated unit includes multiple first sloping regions having the first sloping hole and multiple second sloping regions having the second sloping hole, and the first and second sloping regions are disposed adjacent to each other, and provided along the left-right direction.

### CROSS-REFERENCE TO RELATED APPLICATION

This application is based upon and claims the benefit of priority under 35 USC 119 of Japanese Patent Application No. 2023-103889 filed on Jun. 26, 2023, the entire disclosure of which, including the specification, claims, drawings and abstract, is incorporated herein by reference in its entirety.

### BACKGROUND

### Technical Field

The present disclosure relates to an electronic instrument and an electronic keyboard instrument.

### Description of the Related Art

In conventional electronic instruments which can obtain a key press feeling and tones which are closer to those provided by a real piano, there are known some electronic instruments including a sound releasing hole for releasing a sound emitted from a sound emitting unit such as a loudspeaker to the outside of a casing of the electronic instrument. For example, Japanese Unexamined Patent Application Publication No. 11-52955 (JP-A-11-52955) discloses a loudspeaker device of an electronic organ which includes two loudspeakers and two grilles which are provided in such a manner as to face the corresponding loudspeakers to function as sound releasing holes. In this loudspeaker device, the grilles are each made up of a horizontally variable grille and a vertically variable grille, and a sound releasing angle at which a sound emitted from the loudspeaker is released from the horizontally variable grille and the vertically variable grille can be changed by changing angles of blades of the horizontally and vertically variable grilles.

### SUMMARY

According to an aspect of the present disclosure, there is provided an electronic instrument including a casing, a controller provided with respect to the casing, aligned in a left-right direction of the casing, and extending in a front-back direction of the casing, a sound emitting unit provided within the casing, and a perforated unit comprising a wall extending in the left-right direction, a first sloping hole opened in the wall, sloping from an inside towards an outside of the casing at an acute angle with respect to the front-back direction, and a second sloping hole opened in the wall, sloping from the inside towards the outside of the casing at a larger acute angle with respect to the front-back direction than the acute angle at which the first sloping hole slopes, wherein the perforated unit comprises multiple first sloping regions comprising the first sloping hole and multiple second sloping regions comprising the second sloping hole, and wherein with the multiple first sloping regions and the multiple second sloping regions being disposed adjacent to each other, and the multiple first sloping regions and the multiple second sloping regions are provided along the left-right direction.

According to another aspect of the present disclosure, there is provided an electronic keyboard instrument including the electronic instrument described above, wherein the controller includes a keyboard having multiple keys.

### BRIEF DESCRIPTION OF THE DRAWINGS

FIG. 1 is an overall perspective view of an electronic keyboard instrument according to a first embodiment of the present disclosure as viewed from a front side;

FIG. 2 is a perspective view of a main body part of the electronic keyboard instrument according to the first embodiment as viewed from a back side;

FIG. 3 is a perspective view of the main body part of the electronic keyboard instrument according to the first embodiment as viewed from the front side, with a front top plate and a right side plate removed;

FIG. 4 is a sectional view of the main body part of the electronic keyboard instrument according to the first embodiment, which is a sectional view taken along a line IV-IV in FIG. 2;

FIG. 5 is a perspective view of a part of the main body part of the electronic keyboard instrument according to the first embodiment as viewed from the back side;

FIG. 6 is a perspective view of a sound releasing unit of the electronic keyboard instrument according to the first embodiment as viewed from the back side;

FIG. 7 is a sectional view of the sound releasing unit of the electronic keyboard instrument according to the first embodiment, which corresponds to a sectional view of a section taken along a line VII-VII in FIG. 6;

FIG. 8 is a sectional view of the sound releasing unit of the electronic keyboard instrument of the first embodiment, which corresponds to a sectional view of a section taken along a line VIII-VIII in FIG. 6;

FIG. 9 is a front view of a sound releasing unit of an electronic keyboard instrument according to a second embodiment;

FIG. 10A is a schematic sectional view illustrating a molding method of the sound releasing unit of the electronic keyboard instrument according to the first embodiment; and

FIG. 10B is a schematic sectional view illustrating a molding method of the sound releasing unit of the electronic keyboard instrument according to the second embodiment.

### DESCRIPTION OF THE EMBODIMENTS

### First Embodiment

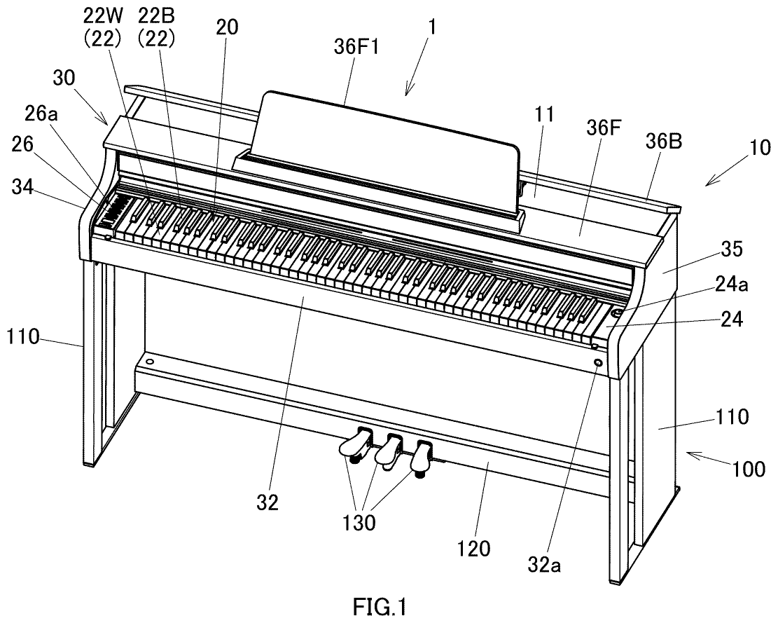

Referring to FIGS. 1 to 8, a first embodiment of the present disclosure will be described. An electronic keyboard instrument (an electronic instrument) 1 shown in FIG. 1 includes a main body part 10 and a leg part 100. As shown in FIG. 1, the main body part 10 includes a keyboard (a controller) 20 and a main body case (a casing) 30 which surrounds the keyboard 20 to hold it. The keyboard 20 has multiple keys 22 made up of white keys 22W and black keys 22B, and in the keyboard 20, a key press section is provided in such a manner as to be exposed to an exterior of the keyboard 20. The leg part 100 includes a pair of side plates 110, a pedal frame 120, and a pedal device 130. In the following description, an alignment direction of the multiple keys 22 of the keyboard 20 is referred to as a left-right direction (in FIG. 1, a direction towards a left side is referred to as a leftward direction), an extending direction of each key 22 is referred to as a front-back direction (in FIG. 1, a direction towards a nearer side is referred to as a frontal direction), and an upper-lower direction of the electronic keyboard instrument 1 is referred to as an upper-lower direction (in FIG. 1, a direction towards an upper side is referred to as an upper direction).

As shown in FIG. 1, the pair of side plates 110 are plates which are erected on a setting surface on both left and right sides of the electronic keyboard instrument 1 in such a posture that both plate surfaces of each plate are oriented in the left-right direction so as to support the main body case 30. The pedal frame 120 extends between the side plates 110 to connect them together at lower sides of the side plates 110. The pedal device 130 is provided substantially at a central portion of the pedal frame 120 in the left-right direction. In the electronic keyboard instrument 1, the main body case 30 of the main body part 10, which is exposed to an exterior of the electronic keyboard instrument 1, and both the side plates 110 of the leg part 100 are made of wood, whereby the quality of the electronic keyboard instrument 1 is characterized by these wood constituent components. Hereinafter, a configuration of the main body port 10 will be described in detail.

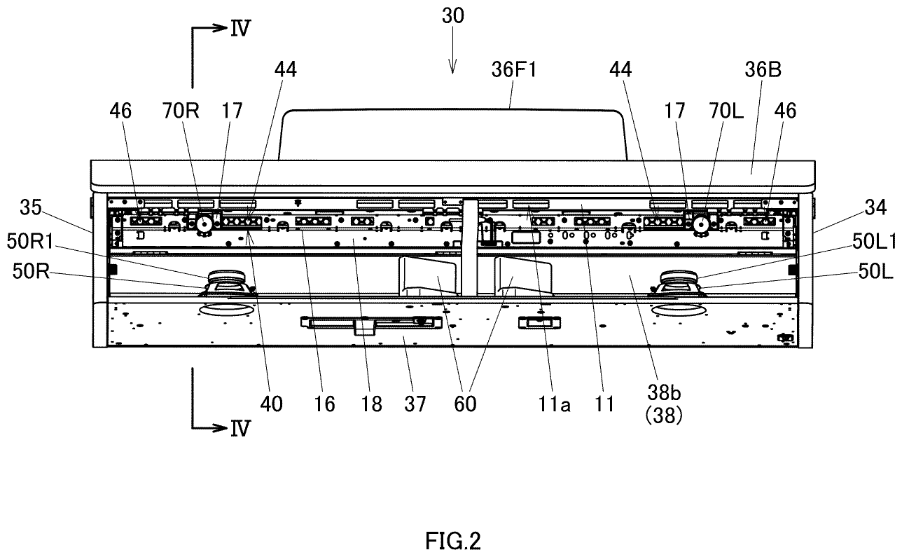

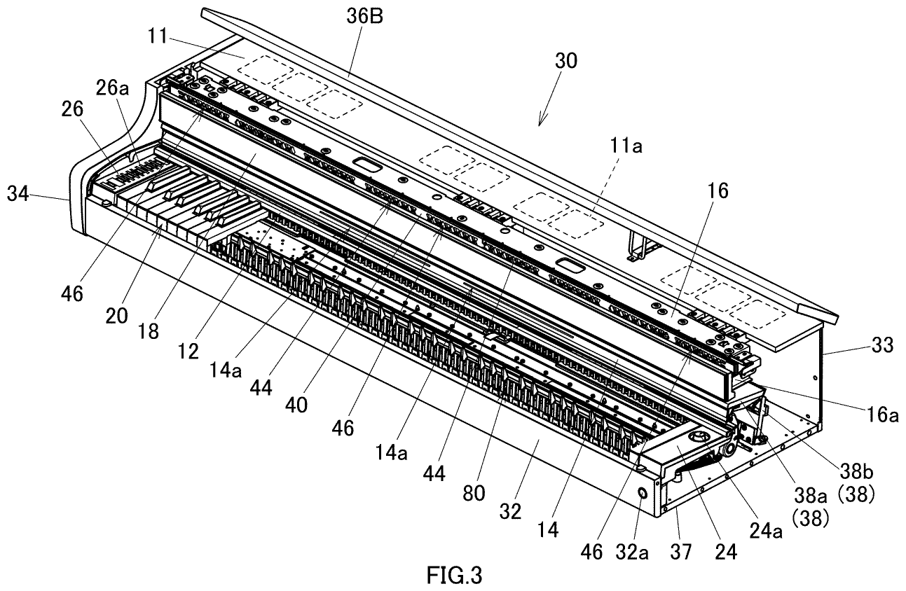

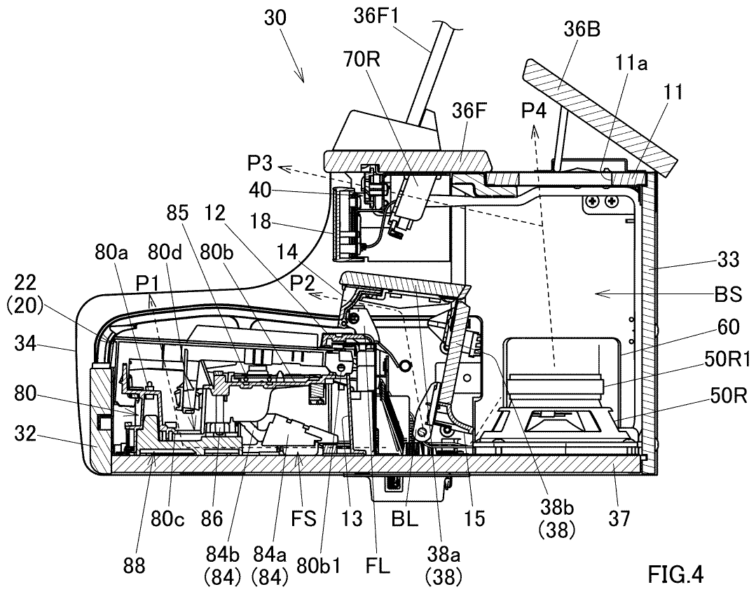

As shown in FIGS. 1 to 4, when viewed from an upper side and a lower side thereof, the main body case 30 has a substantially rectangular shape which is elongated laterally in such a manner that a longitudinal direction thereof follows the left-right direction and has thick plates such as a front plate 32, a back plate 33, a left side plate 34, a right side plate 35, a front top plate (a second plate-shaped unit) 36F, a back top plate 36B, and a lower plate 37. In addition, the main case body 30 has substantially an L-shaped vertical section (refer to FIG. 4). Here, in FIG. 2, the main body case 30 is shown being in a state in which the back plate 33 is removed, and in FIG. 3, the main body case 30 is shown being in a state in which the right side plate 35 and the front top plate 36F are removed. The front plate 32 has a substantially rectangular shape which is elongated in the left-right direction and is provided at a lower portion of a front end portion of the main body part 10 and on a lower side of the keyboard 20, constituting a front surface of the main body case 30. A power supply button 32a is provided at a right end portion of the front plate 32. The back plate 33 has a substantially rectangular shape which is elongated in the left-right direction and is provided on a back side of the main body part 10, constituting a back surface of the main body case 30.

The left side plate 34 and the right side plate 35 each have a substantially rectangular shape which is elongated in the front-back direction. In each of the left side plate 34 and the right side plate 35, a step is provided at a substantially central portion in the front-back direction so that a height of a front half portion becomes substantially equal to the height of the keyboard 20. The left side plate 34 and the right side plate 35 are provided individually on a left side and a right side of the main body part 10, constituting a left side surface and a right side surface of the main body case 30, respectively. The front top plate 36F has a substantially rectangular shape which is elongated in the left-right direction and is provided on a front side of an upper backward portion of the main body part 10, constituting a part of an upper surface of the main body case 30. The back top plate 36B has a substantially rectangular shape which is elongated in the left-right direction and is provided on a back side of the upper backward portion of the main body part 10, constituting a part of the upper surface of the main body case 30. Here, as shown in FIGS. 1 and 3, a volume panel 24 on which a volume knob 24a and the like are disposed is provided between the keyboard 20 and the right side plate 35. In addition, a setting panel 26 on which various types of setting buttons 26a are disposed is provided between the keyboard 20 and the left side plate 34.

As shown in FIGS. 1 and 4, the back top plate 36B is attached rotatably to the back plate 33 in such a manner that the back plate 33 is opened from a front side thereof. A cover plate 11, having a substantially rectangular plate-like shape which is elongated in the left-right direction, is provided on a lower side of the back top plate 36B in such a posture that both plate surfaces thereof are oriented in the upper-lower direction. Multiple upper openings 11a, each having a substantially rectangular shape and opened upwards, are provided in the cover plate 11 in such a manner as to be disposed at predetermined intervals in the left-right direction (refer to FIG. 2). An upper surface and side surfaces of the cover plate 11 are covered with a saran net. With the back top plate 36B left open, an opening on a lower side of the back top plate 36B is covered by the cover plate 11, so that an interior of the main body case 30 is made invisible. In addition, a music stand 36F1 is attached to a substantially central portion of the front top plate 36F in the left-right direction thereof. The lower plate 37 has a substantially rectangular shape which is elongated in the left-right direction and is provided on a lower side of the main body part 10, constituting a lower surface of the main body case 30.

As shown in FIGS. 3 and 4, a console unit 12, having a substantially rectangular plate-like shape which is elongated in the left-right direction, is provided on back sides of the keys 22 of the keyboard 20 in such a posture that both plate surfaces thereof are oriented in the upper-lower direction. The console unit 12 is provided in such a manner as to cover back end portions of the keys 22 of the keyboard 20 in a position where the console unit 12 is superposed on a front end portion of the front top plate 36F in the upper-lower direction. The console unit 12 prevents the interior of the main body case 30 from becoming visible via a gap at a back end portion of the keyboard 20 from an exterior of the electronic keyboard instrument 1. In addition, the keys 22 are restricted from moving in the front-back direction by providing the console unit 12 on the back sides of the keys 22.

As shown in FIG. 4, multiple first metallic sheets 13 are provided at a back end portion of a lower surface of the console unit 12 in such a manner as to be disposed at predetermined intervals along the left-right direction. The multiple metallic sheets 13 each have a substantially plate-like shape and extend downwards in such a posture that both sheet surfaces thereof are oriented in the front-back direction. The lower end portions of the first metallic sheets 13 are attached to the lower plate 37. A back side of the keyboard 20 is fixed to the main body case 30 by the first metallic sheets 13. A space defined on front sides of the first metallic sheets 13 constitutes a space provided below the keyboard 20. Multiple notches, not shown, are provided individually in lower end portions of the first metallic sheets 13. In the interior of the main body case 30, the space defined on the front sides of the first metallic sheets 13 and a space defined on back sides of the first metallic sheets 13 are made to communicate with each other via interspaces between the multiple first metallic sheets 13 and the notches provided in the first metallic sheets 13.

As shown in FIG. 3, in the main body case 30, a section defined between the front plate 32 and the console unit 12 is opened forwards and upwards, so that upper surfaces, constituting key press portions, and portions of front surfaces of the keys 22 of the keyboard 20 are exposed to the outside from this open section. As shown in FIGS. 3 and 4, the main body part 10 includes a key cover 38 for covering the section of the keyboard 20 which is exposed to the outside. The key cover 38 is made up of a thick plate and includes a front cover section 38a and a back cover section 38b, which are each made up of a plate having a substantially rectangular shape which is elongated in the left-right direction. Then, the front cover section 38a and the back cover section 38b are aligned parallel in the front-back direction. The front cover section 38a is rotatably connected with a front link FL fixed to the main body case 30 via a front attachment 14, which is laterally elongated. Two attachment openings 14a, each having a substantially rectangular shape which is laterally elongated, are provided individually on a left side and a right side of a central portion (a handle section) of the front attachment 14 in the left-right direction in such a manner as to be opened to penetrate the front attachment 14 (refer to FIGS. 3 to 5).

The back cover section 38b is rotatably connected with a back link BL fixed to the main body case 30 via a back attachment 15, which is laterally elongated. The front cover section 38a and the back cover section 38b are coupled together via a hinge in such a manner as to be folded into two sections and are accommodated in the space defined on the back sides of the first metallic sheets 13 in the interior of the main body case 30 in such a manner that the key cover 38 can freely be pulled into and out of the relevant space through a gap defined between the console unit 12 and an operation plate 18, which will be described later. In the electronic keyboard instrument 1, when the power supply is switched off, the key cover 38 is pulled out of the interior of the main body part 10 to cover the open section of the main body case 30 where the keyboard 20 is exposed, whereby the exposed section of the keyboard 20 is designed to be covered.

In the electronic keyboard instrument 1, when the keyboard 20 is covered by the key cover 38, the gap defined between the console unit 12 and the operation plate 18 is covered by the back attachment 15. Additionally, when the power supply is switched on and the key cover 38 is accommodated in the space defined on the back sides of the first metallic sheets 13, a slight gap is defined between the lower plate 37 and the back attachment 15. As a result of this, with the key cover 38 accommodated accordingly, the interior of the main body case 30 is defined into a front space FS defined on a front side of the key cover 38 and a back space BS defined on a back side of the key cover 38.

As shown in FIGS. 3 and 4, a second metallic sheet 16 is attached to a lower surface of the front top plate 36F (not shown in FIG. 3) in such a manner as to extend in the left-right direction. The operation plate 18 (a first plate-shaped unit), having a substantially thick rectangular plate-like shape which is elongated in the left-right direction, is provided at a front end portion of the second metallic sheet 16 in such a posture that both sheet surfaces thereof are oriented in the front-back direction. The operation plate 18 is provided between the key cover 38 and the front top plate 36F in such a state that the operation plate 18 is disposed in a position where gaps are defined on both upper and lower sides thereof in such a manner as to be opened towards the front side. Most of a gap defined between the key cover 38 and the front top plate 36F is covered by the operation plate 18, whereby the back space BS is made invisible. A part of a front surface of the operation plate 18 is made into a touch panel, where multiple switches, not shown, are provided to receive touch operations. As a result, the operation plate 18 has a touch operation detection mechanism for enabling a touch operation and an LED light emitting mechanism for illuminating the switches in an interior thereof.

A step 16a, which takes the form of one of a series of steps of a staircase, is provided on a front side of the second metallic sheet 16. A perforated unit 40, having a substantially rectangular plate-like shape which is elongated in the left-right direction, is attached to this step 16a with screws in such a posture that both unit surfaces thereof are oriented in the front-back direction. The perforated unit 40 is formed from a resin through injection molding and has a wall 42 in which multiple holes (low-angled sloping holes 44 and high-angled sloping holes 46, both of which will be described later) are provided in such a manner as to penetrate the perforated unit 40 in a thickness direction thereof. Then, the perforated unit 40 is provided on the second metallic sheet 16 on a back side of the operation plate 18 in such a manner as to define a slight gap between the operation plate 18 and itself in the front-back direction. As shown in FIG. 4, a lower portion of the perforated unit 40 overlaps the operation plate 18 in the front-back direction. The configuration of the perforated unit 40 will be described in detail later.

As shown in FIGS. 2 and 4, the electronic keyboard instrument 1 includes two loudspeakers (a first sound emitting unit) 50R, 50L on a back side of an upper surface of the lower plate 37 in the back space BS. Both the loudspeakers 50R, 50L are provided downwards and backwards of the keyboard 20 in such a manner that sound emitting sections 50R1, 50L1, each having a shape of frustum of circular cone, are disposed above the lower plate 37. Sounds emitted from the sound emitting sections 50R1, 50L1 are emitted into the back space BS. Of the two loudspeakers 50R, 50L, the loudspeaker 50R (hereinafter, also referred to as the “right loudspeaker 50R”) is provided on an upper surface of the lower plate 37 in a position lying closer to the right side and functions to emit sounds in a high-pitched sound range. The loudspeaker 50L (hereinafter, also referred to as a “left loudspeaker 50L”) is provided on the upper surface of the lower plate 37 in a position lying closer to the left side in such a manner as to be aligned parallel to the right loudspeaker 50R in the left-right direction and functions to emit sounds in a low-pitched sound range.

Two reflection units 60 are provided parallel to each other in the left-right direction on a back side of the upper surface of the lower plate 37 while being disposed between the two loudspeakers 50R, 50L, specifically, in a position lying closer to a central portion in the left-right direction to reflect sounds emitted from both the right and left loudspeakers 50R, 50L. The reflection units 60 are each made up of substantially a thick plate which is disposed in such a posture that both plate surfaces thereof are slightly inclined with respect to the left-right direction and are attached to the lower plate 37 by being screwed down thereto at lower end portions thereof. Front surfaces of the reflection units 60 are formed individually into a reflection surface (not shown) configured to reflect sound. These reflection surfaces are inclined towards the right loudspeaker 50R, and hence, at least a part of a sound emitted from the right loudspeaker 50R is reflected towards the front side and a substantially central portion in the left-right direction by the reflection surfaces.

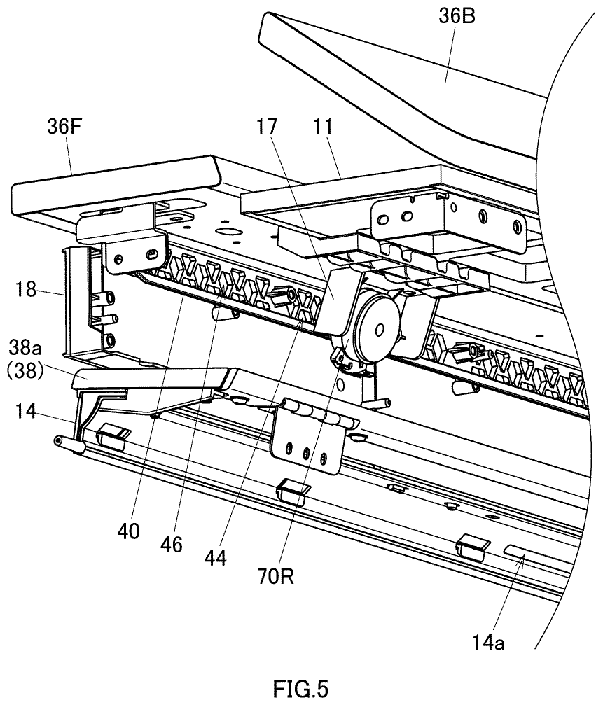

Tweeters 70R, 70L (a second sound emitting unit) are provided individually in positions lying obliquely upwards to the front side from the corresponding loudspeakers 50R, 50L in the back space BS. The tweeters 70R, 70L each have a substantially circular cylindrical shape and are attached individually to the second metallic sheet 16 via a submetallic sheet 17 (refer to FIGS. 4 and 5) which is attached to an internal surface side of the second metallic sheet 16 in such a manner that a cylindrical axis direction and a sound emitting direction are oriented to the front side and obliquely upwards. Hereinafter, the tweeter 70R provided at a right end side of the back space BS is also referred to as the “right tweeter 70R”, and the tweeter 70L provided at a left end side of the back space BS is also referred to as the “left tweeter 70L”.

Subsequently, configurations of constituent components provided in the front space FS will be described. As shown in FIG. 4, a first support 80 is provided on the front sides of the first metallic sheets 13 in the front space FS. The first support 80 is provided over substantially a whole area of the lower side of the keyboard 20 and is laterally elongated as with the keyboard 20. The first support 80 is a hollow component which is opened downwards. The keyboard 20 is supported on the main body case 30 by the first support 80 and a second support 88, which will be described later. The second metallic sheet 16 described above is provided on a back side of the first support 80.

A front end portion of the first support 80 is made into a convex section 80a which protrudes upwards into a convex shape. A portion of the first support 80 which is positioned on lower sides of the black keys 22B of the keys 22 is made into a platform section 80b which protrudes upwards into a platform-like shape. A portion of the first support 80 lying between the convex section 80a and the platform section 80b is made into a concave section 80c which is recessed downwards into a concave shape. A rotatable fulcrum portion 80b1 is provided at a back portion of an upper surface of the platform section 80b so as to support rotatably back end portions of the keys 22 of the keyboard 20. Additionally, a control substrate 85 is provided on the upper surface of the platform section 80b. Switches are provided on the control substrate 85 so as to produce sounds corresponding to the keys 22 which are pressed. Multiple concave section openings 80d, which are opened in the front-back direction and the left-right direction, are provided in the concave section 80c in such a manner as to be aligned side by side in the left-right direction (refer to FIG. 4).

Multiple hammers 84, which are connected with the corresponding keys 22, are provided in a part of a space defined inside the first support 80 which lies below the platform section 80b. The hammer 84 includes a substantially triangular weight section 84a and an arm section 84b, which extends in a straight line to the front side from the weight section 84a. The arm section 84b is rotatably supported on a pivot 86 provided in a front portion of the space defined inside the platform section 80b. When the key 22 is pressed, the weight section 84a of the corresponding hammer 84 is raised, allowing weight to be added during the pressing of each key 22. This makes it possible to obtain a key press feeling close to that provided by a real piano.

The second support 88 is disposed on the lower plate 37 and is provided in a portion of the space defined inside the first support 80 which lies further forwards than a portion where the hammers 84 are disposed. The second support 88 is a hollow component which is opened downwards and is attached to the main body case 30 by being screwed down onto the lower plate 37. The keyboard 20 is indirectly supported on the main body case 30 made of wood via the first support 80 by the second support 88. The pivot 86 which supports the arm section 84b of the hammer 84 is provided on the second support 88.

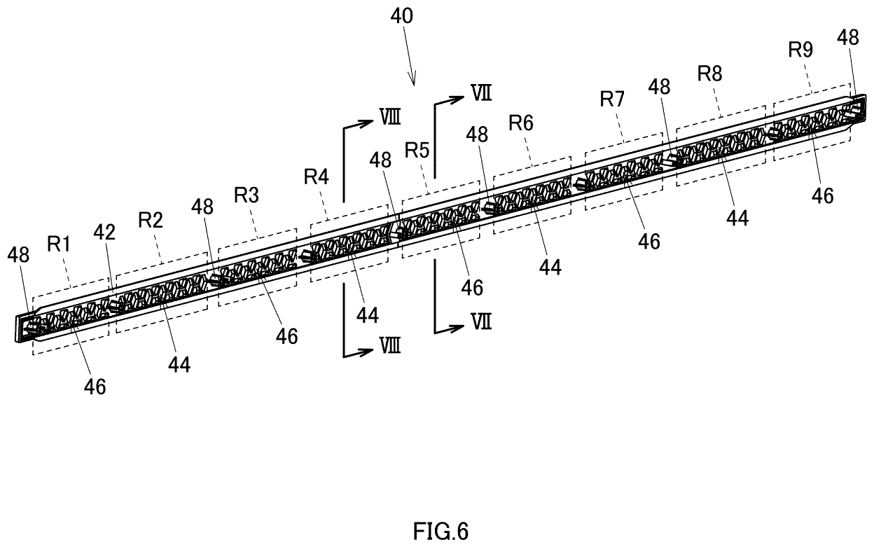

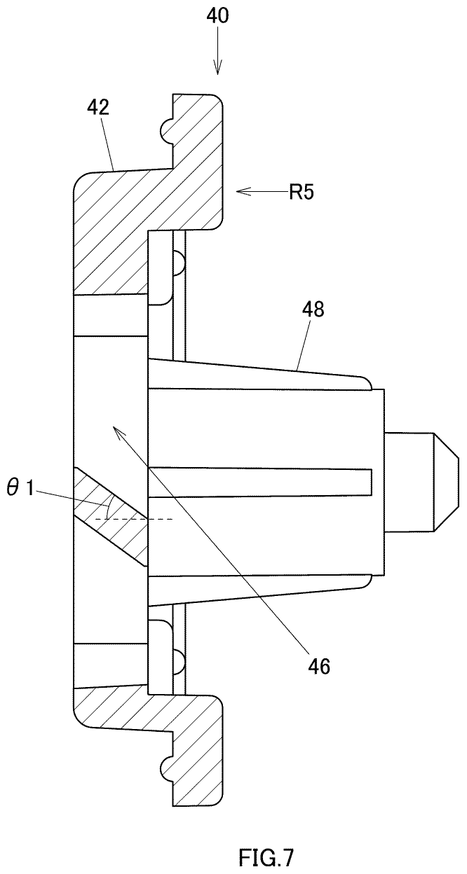

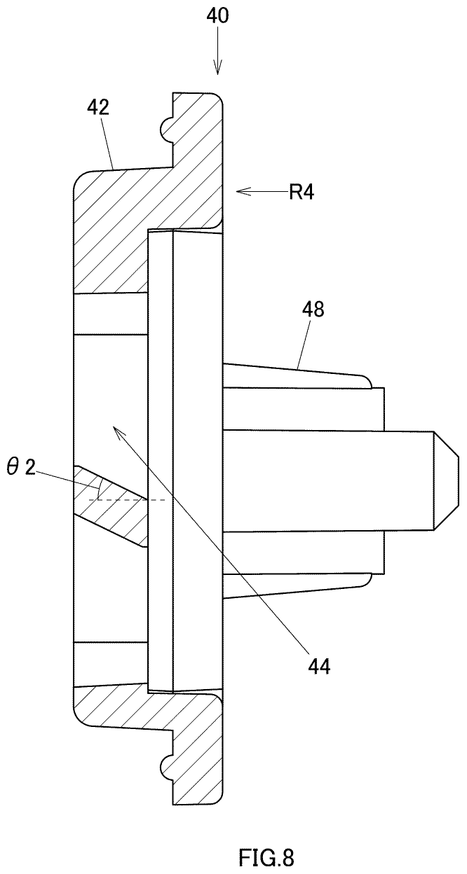

Subsequently, the perforated unit 40 provided on the back side of the operation plate 18 will be described in detail. As shown in FIG. 6, the perforated unit 40 has the wall 42 of a substantially rectangular plate-like shape which is elongated in the left-right direction. Multiple low-angled sloping holes (a first sloping hole) 44 and high-angled sloping holes (a second sloping hole) 46 are provided in the wall 42 in such a manner as to be opened to penetrate the wall 42 substantially in the front-back direction. Here, FIGS. 7 and 8 show sections of the high-angled sloping hole 46 and the low-angled sloping hole 44, respectively, and in these figures, a left side is referred to as a front side. As shown in FIG. 8, the low-angled sloping hole 44 is a hole which is opened in the wall 42 in such a manner as to slope upwards from an inside towards an outside (a front side) of the main body case 30 at an angle θ2 which forms an acute angle with respect to the front-back direction. On the other hand, as shown in FIG. 7, the high-angled sloping hole 46 is a hole which is formed in the wall 42 in such a manner as to slope upwards from the inside towards the outside of the main body case 30 at an angle θ1 which forms an acute angle larger than that of the low-angled sloping hole 44 with respect to the front-back direction (in other words, at a steeper angle).

The perforated unit 40 is disposed in such a manner that the low-angled sloping holes 44 and the high-angled sloping holes 46 slope upwards towards the gap defined between the operation plate 18 and the front top plate 36F. The multiple low-angled sloping holes 44 and high-angled sloping holes 46 are each arranged substantially into a honeycomb structure in which the low-angled sloping holes 44 and high-angled sloping holes 46 are each provided adjacent to one another while being disposed in a staggered fashion in the upper-lower direction. Then, when viewed in a cross-section cut in the left-right direction, it is shown that the low-angled sloping holes 44 and the high-angled sloping holes 46 which are disposed at the same height appear at predetermined intervals. Additionally, as shown in FIGS. 7 and 8, upper and lower end portions of the wall 42 are made to protrude outwards while forming a step towards an inside thereof, and the low-angled sloping hole 44 and the high-angled sloping hole 46 are formed in a portion of the wall 42 defined between the upper and lower end portions thereof.

As shown in FIG. 6, the wall 42 is divided into nine regions R1 to R9 along the left-right direction. These regions R1 to R9 are sized substantially equally. A region R2 facing the right tweeter 70R and a region R8 facing the left tweeter 70L are provided slightly longitudinally longer (a left-right dimension) than the remaining regions R1, R3 to R7, and R9. The regions R1 to R9 are made up of the multiple low-angled sloping regions (first sloping regions) R2, R4, R6, R8 each having the low-angled sloping holes 44 and the multiple high-angled sloping regions (second sloping regions) R1, R3, R5, R7, R9 each having the high-angled sloping holes 46. The low-angled sloping regions R2, R4, R6, R8 and the high-angled sloping regions R1, R3, R5, R7, R9 are provided in the wall 42 in such a manner as to be disposed alternately along the left-right direction. In other words, the low-angled sloping regions R2, R4, R6, R8 and the high-angled sloping regions R1, R3, R5, R7, R9 are provided in the wall 42 in such a manner that the low-angled sloping region and the high-angled sloping region are disposed adjacent to each other. Specifically speaking, both end portions and a central portion of the wall 42 in the left-right direction are made into the sloping regions R1, R9, and the sloping region R5, respectively.

Here, in the first embodiment, a sloping angle at which the low-angled sloping hole 44 slopes upwards in the low-angled sloping regions R2, R8 which are provided individually on right and left sides of the wall 42 in the left-right direction is made smaller than a sloping angle at which the low-angled sloping hole 44 slopes upwards in the low-angled sloping regions R4, R6 which are provided individually on right and left sides of the central portion of the wall 42 in the left-right direction. In addition, a sloping angle at which the high-angled sloping hole 46 slopes upwards in the high-angled sloping region R5 which is provided at the central portion of the wall 42 in the left-right direction is made smaller than a sloping angle at which the high-angled sloping hole 46 slopes upwards in the high-angled sloping regions R1, R3, R7, R9 which are provided on the right and left sides of the wall 42 in the left-right direction. Specifically speaking, the sloping angle of the low-angled sloping hole 44 with respect to the front-back direction in the low-angled sloping regions R2, R8 is 20 degrees, while the sloping angle of the low-angled sloping hole 44 with respect to the front-back direction in the low-angled sloping regions R4, R6 is 26 degrees. In addition, the sloping angle of the high-angled sloping hole 46 with respect to the front-back direction in the high-angled sloping region R5 is 36 degrees, while the sloping angle of the high-angled sloping hole 46 with respect to the front-back direction in the high-angled sloping regions R1, R3, R7, R9 is 46 degrees.

Screw holes 48 are provided individually at left and right ends of the wall 42 and boundary portions defined on the wall 42 to lie individually between the regions R1 to R7 in such a manner as to penetrate the wall 42 in the front-back direction so as to screw the perforated unit 40 onto the second metallic sheet 16. Then, the perforated unit 40 is attached to the second metallic sheet 16 so that the gap defined between the operation plate 18 and the front top plate 36F is positioned on extensions of penetrating directions of the low-angled sloping holes 44 and the high-angled sloping holes 46 which are provided to penetrate the wall 42 while sloping upwards (refer to FIG. 4). Here, a front surface and side surfaces of the wall 42 of the perforated unit 40 are covered with a saran net; however, the saran net is omitted from illustration in the drawings except for FIGS. 2 and 5.

Here, referring to FIG. 5, a positional relationship between the tweeters 70R, 70L and the perforated unit 40 will be described. FIG. 5 is a perspective view of some of the constituent components which illustrates a positional relationship between the right tweeter 70R and the perforated unit 40 (the second metallic sheet 16 is omitted from illustration). As shown in FIG. 5, the right tweeter 70R is provided in such a manner as to face a right end side of the perforated unit 40 above the keyboard 20 while being spaced apart from the perforated unit 40 (similarly, the left tweeter 70L is also provided in such a manner as to face a left end side of the perforated unit 40 above the keyboard 20). Specifically speaking, the right tweeter 70R is provided in such a manner as to face the low-angled sloping region R2 of the perforated unit 40, and the left tweeter 70L is provided in such a manner as to face the low-angled sloping region R8 of the perforated unit 40. The tweeters 70R, 70L are made to slope upwards towards the perforated unit 40, and a sloping angle (that is, a sound emitting angle) thereof is set similar to the sloping angle of the low-angled sloping hole 44 in the low-angled sloping regions R2, R8, that is, to 20 degrees.

Subsequently, communication paths P1 to P4 will be described. The communication paths P1 to P4 are provided in the interior of the main body case 30 and constitute sound travelling paths for sounds emitted from the loudspeakers 50R, 50L. As shown in FIG. 4, in the electronic keyboard instrument 1 according to the first embodiment, four communication paths P1 to P4 are provided within the main body case 30 as sound travelling paths along which sounds emitted from the two loudspeakers 50R, 50L travel to reach the outside of the main body case 30. A first communication path P1, which is a first communication path, constitutes a communication path along which sounds emitted from the two loudspeakers 50R, 50L travel by way of the gap defined between the lower plate 37 and the back attachment 15 to reach the front space FS, passes underneath the hammers 84 to travel further from the concave section openings 80d to above the first support 80, and passes through interspaces defined between the keys 22 to reach the outside of the main body case 30.

A second communication path P1, which is a second communication path, constitutes a communication path along which sounds emitted from the two loudspeakers 50R, 50L travel by way of the gap defined between the lower plate 37 and the back attachment 15 to reach the back sides of the first metallic sheets 13, pass upwards around the back sides of the first metallic sheets 13, and travel further from the attachment openings 14a to reach the outside of the main body case 30. Here, at least a part of a sound in the high-pitched sound range which is emitted from the right loudspeaker 50R to travel by way of the first communication path P1 and the second communication path P2 is reflected towards the gap defined between the lower plate 37 and the back attachment 15 by the reflection surface of each reflection unit 60 and then reaches the back sides of the first metallic sheets 13. As a result, the part of the sound in the high-pitched sound rage which is emitted from the right loudspeaker 50R is designed to reach the back sides of the first metallic sheets 13 with good efficiency.

A third communication path P3, which is a third communication path, constitutes a communication path along which sounds emitted from the two loudspeakers 50R, 50L travel upwards through the back space BS, pass through the low-angled sloping holes 44 and the high-angled sloping holes 46 in the perforated unit 40, and travel further from the gap defined between the operation plate 18 and the front top plate 36F to reach the outside of the main body case 30. Here, sounds emitted from the two tweeters 70R, 70L pass through the low-angled sloping holes 44 and the high-angled sloping holes 46 in the perforated unit 40 to reach the outside of the main body case 30, and hence, the sounds travel by way of at least a part of the third communication path P3. A fourth communication path P4, which is a fourth communication path, constitutes a communication path along which sounds emitted from the two loudspeakers 50R, 50L travel upwards through the back space BS to reach the outside of the main body case 30 by way of the upper openings 11a in the cover plate 11.

Here, at least a part of the sound in the high-pitched sound range which is emitted from the right loudspeaker 50R to travel by way of the third communication path P3 and the fourth communication path P4 is reflected towards the upper side of the back space BS by the reflection surfaces 64a of the two reflection units 60. As a result, the part of the sound in the high-pitched sound range which is emitted from the right loudspeaker 50R is made to reach the upper side of the back space BS efficiently. Thus, since the electronic keyboard instrument 1 has the four communication paths P1 to P4 along which sounds are enabled to travel to reach the outside of the case main body 30, so that the sounds can be released from the interior of the main body case 30 towards the player's side (towards the front and the substantially central portion in the left-right direction of the main body case 30) with good efficiency, thereby making it possible to obtain a good sound image.

Subsequently, the operation/working-effect of the sound release through the third communication path P3 will be described in detail. Sounds emitted from the loudspeakers 50R, 50L to travel by way of the third communication path P3 and sounds emitted from the tweeters 70R, 70L are guided obliquely upwards as a result of the low-angled sloping holes 44 and the high-angled sloping holes 46 being made to slope upwards when the sounds pass through the low-angled sloping holes 44 and the high-angled sloping holes 46 in the perforated unit 40. As a result, the sounds travelling towards the perforated unit 40 within the back side BS are propagated efficiently towards the gap defined between the operation plate 18 and the front top plate 36F by the perforated unit 40 and eventually reach the outside of the main body case 30, thereby making it possible to enhance the sound releasing effect by which the sounds traveling by way of the third communication path P3 are directed towards the player.

Further, the multiple low-angled sloping regions R2, R4, R6, R8 and the multiple high-angled sloping regions R1, R3, R5, R7, R9 are provided alternately in the left-right direction in the perforated unit 40. As a result of this configuration, a reduction in the feeling of uniformity of sound reaching the player (hereinafter, referred to as the “feeling of irregularity of sound”) can be suppressed by adjusting the sloping angles of the low-angled sloping holes 44 and the high-angled sloping holes 46 respectively. This reduction in the feeling of uniformity is caused when a variation in magnitude of the volume of sound (variations in magnitude of the volume of sound in the high-pitched sound range and the volume of sound in the low-pitched sound range) released towards the player, that is, the nearer side of the electronic keyboard instrument 1 by way of the third communication path P3 occurs locally along the left-right direction. With the first embodiment, the sound releasing angles of the individual sloping regions R1 to R9 can be optimized by adjusting individually the sloping angles of the low-angled sloping holes 44 and the high-angled sloping holes 46 in the individual sloping regions R1 to R9 as described above. As a result, the feeling of irregularity of sound that is released towards the player by way of the third communication path P3 can be suppressed remarkably.

Here, in the event that the sloping angles of the low-angled sloping holes 44 and the high-angled sloping holes 46 which are provided in the perforated unit 40 are totally the same or that the low-angled sloping regions R2, R4, R6, R8 and the high-angled sloping regions R1, R3, R5, R7, R9 are not provided alternately in the left-right direction, resulting in an unbalanced arrangement of the low-angled sloping holes 44 and the high-angled sloping holes 46, there may be caused a risk of generation of a problem in that sound released through the perforated unit 40 is collected excessively to the head of the player or a problem in that the sound is collected excessively to directions other than the direction towards the player. On the other hand, with the electronic keyboard instrument 1 according to the first embodiment, even in the case that the gap in front of the perforated unit 40 (the gap defined between the operation plate 18 and the front top plate 36F) is narrow as in the case with the first embodiment, the sound released through the perforated unit 40 can be made to expand in the upper-lower direction and the left-right direction. As a result, sound released through the perforated unit 40 can be restrained from being collected to a specific direction.

Below, the electronic keyboard instrument 1 according to the present embodiment is described in comparison with the related technology. With the loudspeaker device disclosed in JP-A-11-52955, the sound releasing angle with respect to the player can be adjusted by making the sound releasing angle of the one grille differ from the sound releasing angle of the other grille. However, the loudspeaker device of JP-A-11-52955 cannot optimize the sound releasing angle with respect to the player without providing the movable or rotatable mechanism.

To solve the problems of the related technology mentioned above, the electronic keyboard instrument 1 according to the first embodiment includes the main body case 30, the keyboard 20 provided within the main body case 30 and having the multiple keys 22 which are aligned in the left-right direction of the main body case 30, the loudspeakers 50R, 50L and the tweeters 70R, 70L which are all provided within the main body case 30, and the perforated unit 40 having the wall 42 extending in the left-right direction, the low-angled sloping holes 44 which are opened in the wall 42 in such a manner as to slope from the inside toward the outside of the main body case 30 at the acute angle with respect to the front-back direction, and the high-angled sloping holes 46 which are opened in the wall 42 in such a manner as to slope from the inside toward the outside of the main body case 30 at the acute angle with respect to the front-back direction which is larger than the acute angle at which the low-angled sloping holes 44 slope upwards. In addition, the perforated unit 40 includes the multiple low-angled sloping regions R2, R4, R6, R8 which each include the low-angled sloping holes 44 and the multiple high-angled sloping regions R1, R3, R5, R7, R9 which each include the high-angled sloping holes 46. Then, with the low-angled sloping regions R2, R4, R6, R8 and the high-angled sloping regions R1, R3, R5, R7, R9 individually disposed adjacent to each other, the multiple low-angled sloping regions R2, R4, R6, R8 and the multiple high-angled sloping regions R1, R3, R5, R7, R9 are provided along the left-right direction.

With the electronic keyboard instrument 1 configured in the way described above, sound passing through the low-angled sloping holes 44 and the high-angled sloping holes 46 in the perforated unit 40 can be guided upwards towards the outside of the main body case 30, that is, towards the player, thereby making it possible to enhance the sound releasing effect by which sounds emitted from the loudspeakers 50R, 50L and the tweeters 70R, 70L to pass through the perforated unit 40 are directed towards the player. Further, the multiple low-angled sloping regions R2, R4, R6, R8 and the multiple high-angled sloping regions R1, R3, R5, R7, R9 are provided alternately along the left-right direction, thereby making it possible to optimize the sound releasing angle sound passing through the perforated unit 40 by adjusting the sound releasing angle along the left-right direction. As a result, the feeling of irregularity of sound passing through the perforated unit 40 to be released towards the player can be reduced.

In addition, with the electronic keyboard instrument 1 according to the first embodiment, the low-angled sloping holes 44 and the high-angled sloping holes 46 are opened in such a manner as to slope forwards and either upwards or downwards from the inside of the main body case. As a result, a specific opening direction can be provided for the low-angled sloping holes 44 and the high-angled sloping holes 46.

With the electronic keyboard instrument 1 according to the first embodiment, there are provided an odd number of low-angled sloping regions R2, R4, R6, R8 and high-angled sloping regions R1, R3, R5, R7, R9 in total. Here, the feeling of irregularity of sound passing through the perforated unit 40 to be released towards the player tends to be influenced more at the central portion in the left-right direction than at the end portions in the left-right direction of the perforated unit 40. When the number of sloping regions R1 to R9 provided in the perforated unit 40 is odd, there is no such situation that a boundary portion between the two types of sloping regions is disposed at the central portion in the left-right direction of the perforated unit 40, and a single region of either the low-angled sloping region or the high-angled sloping region can be disposed at the central portion in the left-right direction of the perforated unit 40. This enables the sound releasing angle of sound passing through the perforated unit 40 to be optimized more effectively.

With the electronic keyboard instrument 1 according to the first embodiment, the perforated unit 40 includes the high-angled sloping region R5 at the central portion in the left-right direction. As a result, sound passing through the perforated unit 40 is propagated further upwards (towards the head of the player) at the central portion in the left-right direction while the sound releasing angle of the sound is optimized effectively, thereby making it possible to enhance the auditory effect by the player.

With the electronic keyboard instrument 1 according to the first embodiment, the perforated unit 40 includes in total nine low-angled sloping regions R2, R4, R6, F8 and high-angled sloping regions R1, R3, R5, R7, R9, and the sloping angle at which the low-angled sloping holes 44 slope upwards is larger in the low-angled sloping regions R4, R6 which are provided respectively on the right and left sides of the central portion in the left-right direction than in the low-angled sloping regions R4, R8 which are provided respectively on the right and left end sides in the left-right direction. Further, the sloping angle at which the high-angled sloping holes 46 slope upwards is smaller in the high-angled sloping region R5 which is provided at the central portion in the left-right direction than in the high-angled sloping regions R1, R9 which are provided respectively at the right and left end portions in the left-right direction. According to this configuration, the low-angled sloping holes 44 and the high-angled sloping holes 46 are provided alternately in the left-right direction, and the sloping angles of the low-angled sloping holes 44 and the high-angled sloping holes 46 which lie adjacent to each other are adjusted individually as described above, whereby the respective sound releasing angles of the sloping regions R1 to R9 can be optimized, and the feeling of irregularity of sound passing through the perforated unit 40 to be released towards the player can be suppressed remarkably.

The electronic keyboard instrument 1 according to the first embodiment includes the operation plate 18 which extends in the left-right direction and which is provided above the keyboard 20 and the front top plate 36F which extends in the left-right direction and which is provided above the operation plate 18 while defining the gap between the operation plate 18 and itself. Then, the perforated unit 40 is disposed in such a manner that the low-angled sloping holes 44 and the high-angled sloping holes 46 slope upwards towards the gap. According to this configuration, sound passing through the low-angled sloping holes 44 and the high-angled sloping holes 46 in the perforated unit 40 can be made to easily reach the outside of the main body case 30, that is, the player, thereby making it possible to enhance the auditory effect by the player.

The electronic keyboard instrument 1 according to the first embodiment includes, as sound emitting units, the loudspeakers 50R, 50L which are provided downwards and backwards of the keyboard 20 and the tweeters 70R, 70L which are provided to face the end portions in the left-right direction of the perforated unit 40 above the keyboard 20. According to this configuration, sounds from the tweeters 70R, 70L can be made to pass through the low-angled sloping holes 44 and the high-angled sloping holes 46 which are provided at the end portions in the left-right direction of the perforated unit 40 while making sounds from the loudspeakers 50R, 50L pass through all the low-angled sloping holes 44 and the high-angled sloping holes 46 that are provided in the perforated unit 40. As a result, the acoustic effect of sound which passes through the perforated unit 40 to reach the player can be enhanced by the synergistic effect of sounds from the loudspeakers 50R, 50L and sounds from the tweeters 70R, 70L.

### Second Embodiment

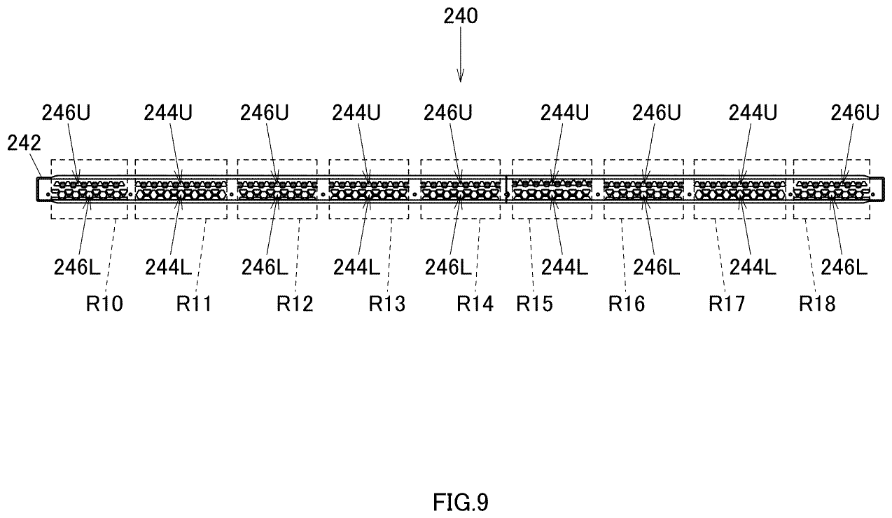

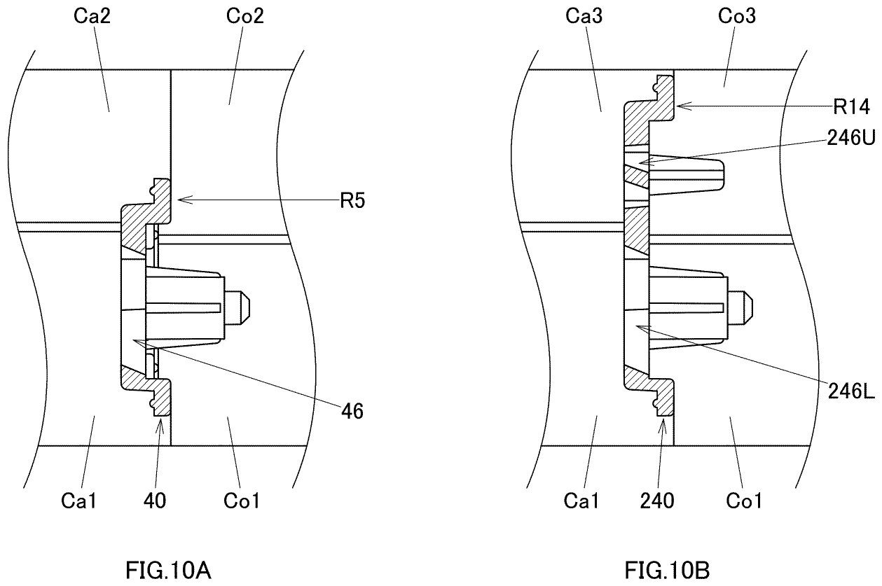

Subsequently, referring to FIGS. 9, 10A, and 10B, a second embodiment of the present disclosure will be described. As shown in FIGS. 9, 10A, and 10B, an electronic keyboard instrument according to the second embodiment differs from the electronic keyboard instrument 1 according to the first embodiment in the configuration and shape of a perforated unit 240. The configurations and operation/working-effects of the other constituent components are the same as those of the first embodiment, and hence, the description thereof will be simplified or omitted. In the second embodiment shown in FIGS. 9, 10A, and 10B, like reference characters/numerals to those of the first embodiment will be given to like constituent components to those of the first embodiment.

As shown in FIG. 9, in the perforated unit 240 of the second embodiment, as with the perforated unit 40 of the first embodiment, a wall 142 is divided into nine regions R10 to R18 along a left-right direction thereof. With the high-angled sloping regions R10, R18 disposed respectively at right and left end portions in the left-right direction of the wall 142, the low-angled sloping regions R11, R13, R15, R17 and the high-angled sloping regions R10, R12, R14, R16, R18 are provided alternately along the left-right direction. Further, in the perforated unit 240, low-angled sloping holes and high-angled sloping holes are provided extending over two stages in an upper-lower direction (also, refer to FIGS. 10A and 10B). In the following description, a low-angled sloping hole and a high-angled sloping hole which are provided in the lower stage will be referred to as a “lower low-angled sloping hole 244L” and a “lower high-angled sloping hole 246L”. In addition, a low-angled sloping hole and a high-angled sloping hole which are provided in the upper stage will be referred to as an “upper low-angled sloping hole 244U” and an “upper high-angled sloping hole 246U”.

In the perforated unit 240 which is divided into a two-stage structure, a lower-stage part is configured identical to the perforated unit 40 of the first embodiment. That is, the shape, size, and sloping angles of the sloping holes of the lower-stage part of the perforated unit 240 are identical to those of the perforated unit 40 of the first embodiment, and the right and left end portions and a central portion in the left-right direction of the wall 242 or the perforated unit 240 are formed respectively into the high-angled sloping regions R10, R18, R14. In addition, the lower-stage part (the lower low-angled sloping holes 244L, the lower high-angled sloping holes 246L) of the perforated unit 240 is disposed and sized so as to face an operation plate 18 in a front-back direction. As a result, most of sound travelling from an interior side of a main body case 30 to pass through the openings or holes in the perforated unit 240 is designed to pass through the upper low-angled sloping holes 244U and the upper high-angled sloping holes 246U to exit from a gap defined between the operation plate 18 and a front top plate 36F to the outside of the main body case 30.

Here, the lower low-angled sloping holes 244L and the lower high-angled sloping holes 246L are made to slope towards the gap between the operation plate 18 and the front top plate 36F, and hence, this can prevent sound passing through the openings in the perforated unit 240 from being interrupted when the sound passes through the lower low-angled sloping holes 244L and the lower high-angled sloping holes 246L to exit from the gap between the operation plate 18 and the front top plate 36F to the outside of the main body case 30. The sloping angles of the lower low-angled sloping holes 244L and the lower high-angled sloping holes 246L may be set to steep angles. In this case, a configuration can be provided in which sound passing through the lower low-angled sloping holes 244L and the lower high-angled sloping holes 246L easily exits from the gap between the operation plate 18 and the front top plate 36F to the outside of the main body case 30.

The perforated unit 240 of the second embodiment and the perforated unit 40 of the first embodiment can be fabricated by partially using the common mold. In other words, the lower-stage part (the lower low-angled sloping holes 244L, the lower high-angled sloping holes 246L) of the perforated unit 240 shown in FIG. 10B and most portions (low-angled sloping holes 244, high-angled sloping holes 246) of the perforated unit 40 excluding the upper end portion thereof shown in FIG. 10A are identical in shape, size, and sloping angles of the sloping holes. Hence, the lower-stage part of the perforated unit 240 and the most portions of the perforated unit 40 can be fabricated through injection molding using the common mold made up of a first cavity Ca1 and a first core Co1. On the other hand, the upper end portion of the perforated unit 40 shown in FIG. 10A and an upper-stage part (the upper low-angled sloping holes 244U, the upper high-angled sloping holes 246U) of the perforated unit 240 shown in FIG. 10B can be fabricated through injection molding using different molds which are made up individually of a second cavity Ca2 and a second core Co2, and a third cavity Ca3 and a third core Co3.

Thus, as has been described heretofore, the electronic keyboard instrument according to the second embodiment can provide the same operation/working-effect as that provided by the first embodiment. Further, since the low-angled sloping regions R11, R13, R15, R17 and the high-angled sloping regions R10, R12, R14, R16, R18 are provided alternately along the left-right direction in the perforated unit 240, the feeling of irregularity of sound passing through the perforated unit 240 to be released towards the player can be reduced.

As described above, since the perforated unit 240 of the second embodiment and the perforated unit 40 of the first embodiment can be fabricated partially using the common mold, multiple models having the different perforated units 40, 240 can be fabricated while suppressing the costs incurred for the molds. As a result, multiple types of perforated units 40, 240 can selectively be fabricated depending on the height of a player so as to obtain an optimized sound releasing angle for sound passing through the perforated units 40, 240 while suppressing the costs involved.

Here, the embodiments of the present disclosure that have been described heretofore are presented as examples, and hence, there is no intention to limit the scope of the present disclosure by the embodiments. These novel embodiments can be carried out in other various forms, and various omissions, replacements, and modifications can be made thereto without departing from the spirit and scope of the present disclosure. Those resulting embodiments and modified examples thereof are included in the scope and gist of the present disclosure and are also included in the scope of disclosures claimed for patent under claims below and their equivalents.

What is claimed is:

1. An electronic instrument comprising:
a casing;
a controller provided with respect to the casing, aligned in a left-right direction of the casing, and extending in a front-back direction of the casing;
a sound emitting unit provided in the casing; and
a perforated unit comprising a wall extending in the left-right direction, a first sloping hole opened in the wall, sloping from an inside toward an outside of the casing at an acute angle with respect to the front-back direction, and a second sloping hole opened in the wall, sloping from the inside toward the outside of the casing at a larger acute angle with respect to the front-back direction than the acute angle at which the first sloping hole slopes,
wherein the perforated unit comprises multiple first sloping regions comprising the first sloping hole and multiple second sloping regions comprising the second sloping hole, and
wherein with the multiple first sloping regions and the multiple second sloping regions being disposed adjacent to each other, and the multiple first sloping regions and the multiple second sloping regions are provided along the left-right direction.

2. The electronic instrument according to claim 1,
wherein the first sloping hole and the second sloping hole are opened, the first sloping hole and the second sloping hole sloping forwards and either upwards or downwards from the inside of the casing.

3. The electronic instrument according to claim 1,
Wherein in total, an odd number of the multiple first sloping regions and the multiple second sloping regions are provided.

4. The electronic instrument according to claim 3,
wherein the multiple first sloping regions and the multiple second sloping regions are aligned in the perforated unit, one of the multiple second sloping regions being disposed at a central portion in the left-right direction.

5. The electronic instrument according to claim 4,
wherein the perforated unit comprises a total of nine sloping regions comprised of the multiple first sloping regions and the multiple second sloping regions, and
wherein the first sloping hole in the multiple first sloping regions provided on both sides of a central portion in the left-right direction slopes at a larger angle with respect to the front-back direction than an angle at which the first sloping hole in the multiple first sloping regions provided on both end sides in the left-right direction.

6. The electronic instrument according to claim 4,
wherein the perforated unit comprises a total of nine sloping regions comprised of the multiple first sloping regions and the multiple second sloping regions, and
wherein the second sloping hole in the multiple second sloping region provided at the central portion in the left-right direction slopes at a smaller angle with respect to the front-back direction than an angle at which the second sloping hole in the multiple second sloping regions provided at both end portions in the left-right direction.

7. The electronic instrument according to claim 1, comprising:
a first plate-shaped unit extending in the left-right direction and provided above the controller; and
a second plate-shaped unit extending in the left-right direction, disposed in such a manner as to define a gap between the first plate-shaped unit and itself, and provided above the first plate-shaped unit,
wherein the perforated unit is disposed in such a manner that the first sloping hole and the second sloping hole slope from the inside towards the outside of the casing and upwards towards the gap.

8. The electronic instrument according to claim 7,
wherein the perforated unit comprises the first sloping hole and the second sloping hole extending over two stages in an upper-lower direction, and
wherein the first sloping hole and the second sloping hole in the lower stage are provided in such a manner as to face the first plate-shaped unit in the front-back direction.

9. The electronic instrument according to claim 1,
wherein the sound emitting unit comprises:
a first sound emitting unit provided downwards and rearwards of the controller; and
second sound emitting units provided above the controller in such a manner as to face individually corresponding end portions in the left-right direction of the perforated unit.

10. An electronic keyboard instrument comprising:
the electronic instrument according to claim 1,
wherein the controller includes a keyboard having multiple keys.
